(19) United States
(12) Patent Application Publication
(10) Pub. No.: US 2010/0065363 A1
(43) Pub. Date: Mar. 18, 2010

(54) Backbone motorcycle frame having a partial cradle which supports a rear portion of a unitized engine and transmission and to which foot peg assemblies are bolted

(76) Inventor: Gary A. Goodwin, Eagle Mountain, UT (US)

Correspondence Address: ANGUS C. FOX, III, 4093 N. IMPERIAL WAY, PROVO, UT, 84604-5386, US

(21) Appl. No.: 12/586,134

(22) Filed: Sep. 16, 2009

Related U.S. Application Data
(60) Provisional application No. 61/097,325, filed on Sep. 16, 2008.

(51) Int. Cl. B62M 7/02

(52) U.S. Cl. 180/227

(57) ABSTRACT

The backbone-type frame has a partial rear cradle which includes spaced-apart left and right crescent-shaped, box-section members. A lower brace is welded to and interconnects the lower forward-extending portions of each C-shaped box-section member. The lower brace, which is securable to threaded apertures on the bottom of a unitized engine/transmission case, includes a transverse tube which extends through both box-section members, the tube having a cylindrical aperture on each end thereof. A footpeg mounting bracket having a mounting stud is bolted to each box-section member, with its mouting stud inserted within the cylindrical aperture of one end of the transverse tube or bar. The footpeg mounts are easily replaceable.

This application has a priority date based on Provisional Patent Application No. 61/097,325, which has a filing date of Sep. 16, 2008, and bears the same title.

### BACKGROUND OF THE INVENTION

1. Field of the Invention

This invention relates to motorcycles and motorcycle frames and, more particularly, to backbone-type frames wherein a unitized engine and transmission assembly functions as a stressed structural member.

2. Description of the Prior Art

Modern motorcycles typically comprise the following components: a frame; a rear wheel coupled to the frame via a rear suspension assembly; a front wheel coupled to the frame via a front fork incorporating a front suspension system; a handlebar rigidly coupled to the front fork; a brake associated with each wheel; engine controls and a front brake control mounted on the handlebar; a unitized engine and transmission bolted to the frame; and a drive system coupling the transmission output to the rear wheel. As early motorcycles were essentially modified bicycles, the frames were nothing more than heavy-duty bicycle frames with an engine attached. Over the years, frames were optimized for motorcycle use and eventually incorporated suspension systems and greater rigidity for safer handling. Most frames are constructed of welded-together steel tubing and stamped heavy-gauge steel sheet metal. More exotic frames may be fabricated from aluminum. Frames for lower-performance motorcycles and scooters may be fabricated almost entirely of stamped steel sheet metal pieces that are welded together to create a monocoque frame. Many Honda touring motorcycles of the 1960s, such as the CA-150, CA-160, CA-72 and CA-77 had frames that were fabricated from several large sheet-metal stampings that were welded together. Although most motorcycles have what can be characterized as full-cradle frames, in that a portion of the frame wraps beneath a unitized engine and transmission unit, many motorcycles have been manufactured over the years with spine, or backbone-type, frames where the engine and transmission unit hangs from the frame. For some backbone frame designs, such as the Honda CA series motorcycles and many of the Honda CB series motorcycles of the 1960s, such as the CB-160, the CB-72 and CB-77, and particularly the Honda racing motorcycles of the 1960s, the engine and transmission unit formed a stressed member of the backbone frame. Motorcycles have also been manufactured that had frames that were a combination of cradle and backbone. The Aermacci 250 cc and 350 cc motorcycles built during the 1960s and 1970s had a backbone frame built from tubing that incorporated a partial cradle that extended forward from a lower portion of the backbone and supported the rear of the engine and transmission unit. The BiMoto/Benelli 250 cc 4-stroke-cycle motorcycles had a backbone frame made from stamped sheet metal with a similar partial cradle arrangement. The Aermacci 250/350 cc and BiMoto/Benelli 250 cc were interesting from another standpoint. Both designs employed horizontal single-cylinder engines. With such a layout, the axis of the crankshaft is parallel that of the rear wheel, the cylinder is positioned in front of the crankshaft, and the cylinder axis is horizontal, or nearly so. This engine configuration is believed to provide optimal cooling for a single-cylinder air-cooled engine.

Motorcycles having backbone frames and single-cylinder horizontal engines are still very much alive in today's motorcycle industry. The design is used primarily for motorcycles manufactured in China and Taiwan having engine displacements no greater than 175 cc. Small motocross motorcycles use the design almost exclusively. A standard backbone-type frame for contemporary small displacement motorcycles having horizontal 4-stroke-cycle engines typically has a large single tube or a pair of smaller tubes that run longitudinally from a rear swing arm mount located behind the engine up and over the engine to a front head tube to which the handlebar, front fork, and associated front suspension components are attached. An engine is mounted in such a way that it is suspended or hanging from the frame by two, three, or four mounting points at the top and rear of the engine. There are no frame mounting points at the bottom of the engine. Instead, a footpeg bracket is attached directly to the bottom of the engine/transmission case, typically by means of four nuts, each of which engages a threaded stud which is anchored within a threaded hole in a mounting post cast into the bottom of the engine/transmission case. Those four threaded studs, which are typically 8 millimeters—and never more than 10—millimeters in diameter, must support nearly 100% of a rider's weight when the rider is standing during riding. As riders typically stand on the footpegs when traversing rough terrain, the impact forces exerted on the four threaded studs can frequently be nearly double the weight of the rider. Thus for a rider weighing 90 kilograms (198 lbs.), the four threaded studs will, together, likely see forces of 180 kilograms (396 lbs.). If the nuts on the threaded studs become loose, high impact forces will be applied to the threaded studs through the nuts. One need not be a structural engineer to realize that a failure of the threaded holes, the mounting posts, or both, will occur in short order if the motorcycle is ridden on rough terrain. If a catastrophic failure of the footpeg mounting hardware were to occur, the rider would fall and his feet would strike the ground, causing him to fall face first on top of the motorcycle. In such a situation, a total loss of control would be likely. Given the fact that many of these small displacement motorcycles are raced, a failure of the footpeg assembly will endanger not only the rider, but also nearby competitors. A less likely scenario is that the mounting points, from which the engine/transmission unit is suspended from the frame, will fail, resulting in the engine hitting the ground. Such an event could also be dangerous, and would almost certainly doom the engine/transmission case to the scrap bin.

Over the past several years, there has been a flurry of activity aimed at improving the frame design of these small motorcycles so that failure of the footpeg assembly and/or engine mounting points will not occur under foreseeable operating conditions. One such attempt at design improvement involves U.S. Pat. No. 7,281,727, which issued to John Rogozienski on a patent application filed on Aug. 10, 2004. This design has attempted to ameliorate the problem of a weakly-mounted footpeg assembly by adding a partial cradle to the rear of the backbone frame which supports both the lower rear portion of the engine/transmission unit and the footpeg bracket, which remained unchanged. It does not appear that prior art relating to the Aermacci and BiMoto/Benelli motorcycles of the 1960s was considered at all during examination of the application. A drawback to this modified frame design is that the footpeg assembly cannot be replace without completely removing the engine from the frame. As expected, this patent—which covers a design that is either fully anticipated or obviated by unconsidered prior art—is being asserted against competitors.

Another improved frame design is disclosed in U.S. Patent Application Publication No. US 2007/0012500 A1, which was filed by Duane Brown, et al. On Jun. 5, 2006. For this design, a partial cradle has been added to a rear portion of the frame, which supports a rear portion of the engine/transmission unit. The footpeg mounting bracket, as shown, is either cast or machined from aluminum. It is then installed between the right and left members of the partial cradle using threaded fasteners. With this particular frame design, the footpeg mounting bracket must be removable so that the engine can be secured to the top and rear engine mounts of the frame. Although the application of Brown, et al. suggests that the footpeg mounting bracket might be welded to the frame, such an arrangement is not described. The rear engine mount is mounted to a spacer that is inserted between the inboard ends of the rear suspension swing arm. As there must be a certain amount of play between the spacer and the bolt which secures the rear suspension swing arm to the main frame portion, the connection of the engine to the frame through this rear mount can never be completely rigid. In the drawings of the patent disclosure, the right and left members of the partial cradle each have three holes. The center hole receives a bevel-head bolt which secures the footped mounting bracket to the right and left members of the partial cradle. The outer two holes are threaded and are used to secure a footpeg mounting bracket with bolts to the partial cradle member. There are a number of disadvantages associated with the frame design of Brown, et al. Firstly, Brown's footpeg mounting bracket is expensive to manufacture and will never provide the rigidity, strength and lightness of weight that welded fabrication can provide. This is particularly important in the lower portion of the frame, which is subjected to intense inertial stress from both the rider and the engine. Secondly, in order to remove the engine if the footpeg mounting bracket is welded to the main portion of the frame, the footpeg mounting bracket would need to be cut out of the frame. Third, the floating rear engine mount reduces the structural integrity of the engine/transmission mounting system.

### SUMMARY OF THE INVENTION

The present invention solves the problems of the standard backbone-type frame used for contemporary small displacement motorcycles having horizontal single-cylinder 4-stroke-cycle engines. In addition, it also solves the problems associated with more recent backbone-type frames which incorporate a partial cradle that supports a rear portion of the engine/transmission unit and is tied to the mounting posts on the bottom of the engine/transmission unit that were originally used to mount a footpeg bracket.

The backbone-type frame of the present invention has a partial rear cradle comprised of left and right crescent, or C-shaped, box-section members fabricated primarily of stamped structural sheet metal which “cradle” opposite sides of a rear portion of a unitized horizontal single-cylinder engine/transmission unit. Each of the C-shaped box-section members incorporates a rear swing arm attachment aperture, and the swing arm is secured between the two apertures with a swing arm pivot bolt. In addition, a rear brace is welded to and interconnects the mid portions of both C-shaped box-section members. A rear engine mount bracket is secured to the rear brace. A rear mounting point on the engine/transmission unit can be bolted to the rear engine mount bracket. A lower brace is welded to and interconnects the lower forward-extending portions of each C-shaped box-section member. For a preferred embodiment of the invention, the lower brace includes a transverse tube or bar and a transverse plate on each side thereof, each transverse plate having a pair of apertures. The four apertures align with the threaded apertures of the engine/transmission case which originally intended for anchoring a footpeg bracket to the underside of the engine/transmission case. Each of the transverse plates is welded to the transverse bar and to each of the C-shaped box-section members at opposite ends.

The frame also includes a spine, the anterior end of which is welded to a head tube. For a preferred embodiment of the invention, the spine is fabricated from a pair of generally parallel longitudinal tubes, which extend the full length of the spine, and a longitudinal plate of the same length, which is welded to both longitudinal tubes to form a modified I-beam structure. A pair of tubular struts, which are welded to opposite sides of a posterior end portion of the spine, together form a V configuration and also branch rearwardly and somewhat downwardly from the posterior end portion. Each tubular strut is welded to an upper portion of one of the C-shaped box-section members, thereby completing the basic structure of the new frame. An upper engine mount bracket, which is also welded to the posterior end portion of the spine, is boltable to an upper mounting point on the engine/transmission case. A multi-purpose bracket also welded to an upper edge of the posterior end portion of the spine provides mounting points for a fuel tank and a seat-mount beam which is supported by a pair of bolt-on struts, each of which interconnects a rear portion of the seat-mount beam to a mounting point on an upper portion of each C-shaped box-section member. A lower portion of the left C-shaped box section member also incorporates a rear brake lever pivot tube.

Footpeg mounts are attached to the partial rear cradle via a unique attachment system. Each end of the transverse bar or tube of the lower brace extends through the C-shaped box section member to which it is welded. If a transverse bar rather than a transverse tube is employed in the lower brace, both ends of the bar are axially drilled to create a cylindrical recess that will accept a cylindrical stud. Threaded attachment holes are provided on opposite sides of each cylindrical recess. A footpeg mount includes a footpeg socket to which the actual footpeg attaches with a hinge pin, a mounting plate having a pair of aperture which align with the threaded attachment holes on opposite sides of each cylindrical recess, and a stalk that interconnects the footpeg socket and the mounting plate. A cylindrical mounting stud, which extends from the opposite side of the attachment plate, is axially aligned with the stalk. In order to install the footpeg mount, the mounting stud is inserted within the cylindrical recess and the mounting plate is secured to an associated C-shaped box section member with a pair of attachment bolts. Stresses and loads applied to the footpegs are transferred to the transverse bar or tube, thereby greatly reducing stresses and loads applied to the mounting plate and attachment bolts. A footpeg mount can be easily replaced by simply removing the two attachment bolts, removing the old footpeg mount and installing a new one in its place.

The frame of the present invention has a number of advantages over those of the prior art, and over the frame of Brown, et al. in particular. Firstly, the lower portion of the frame, including the lower engine mount and footpeg mounts, are integral with the rest of the frame. Only the upper engine mount, which is lightly stressed, is bolted to the frame so that it can be removed in order to remove the engine. Secondly, the frame is fabricated completely from steel, and does not require machined aluminum or steel parts for the lower engine mount and footpeg mounts. This feature reduces both manufacturing cost and weight. Thirdly, the rear engine mount is integral and rigidly affixed to the frame, as it does not use the floating arrangement of Brown, et al.

### BRIEF DESCRIPTION OF THE DRAWINGS

FIG. 1 is a perspective exploded view of the new backbone frame and footpeg mounting brackets taken from a left-front vantage point;

FIG. 2 is a perspective view of the new backbone frame of FIG. 1, with the footpeg mounting brackets secured to the frame;

FIG. 3 is a perspective view of the new backbone frame taken from a right-front viewpoint;

FIG. 4 is a left-side elevational view of the new backbone frame, with the footpeg mounting brackets secured to the frame;

FIG. 5 is a right-side elevational view of the new backbone frame;

FIG. 6 is a top plan view of the new backbone frame;

FIG. 7 is a bottom plan view of the new backbone frame;

FIG. 8 is a front elevational view of the new backbone frame;

FIG. 9 is a rear elevational view of the new backbone frame;

FIG. 10 is a perspective view of the new backbone frame to which the seat and rear fender mounting framework has been attached, taken from a right-front vantage point;

FIG. 11 is a left-side elevational view of the new backbone frame to which the seat and rear fender mounting framework has been attached;

FIG. 12 is a perspective view of the new backbone frame to which the swing arm, the spring and shock absorber assembly and the linkage connecting the spring and shock absorber assembly to the swing arm have been attached, taken from an upper left-side vantage point;

FIG. 13 is a cutaway perspective view of the new backbone frame assembly of FIG. 12, but with the left side of the swing arm removed to show details of the suspension linkage arrangement;

FIG. 14 is a front elevational view of the new backbone frame assembly of FIG. 12; and

FIG. 15 is a rear elevational view of the new backbone frame assembly of FIG. 12.

### DETAILED DESCRIPTION OF THE INVENTION

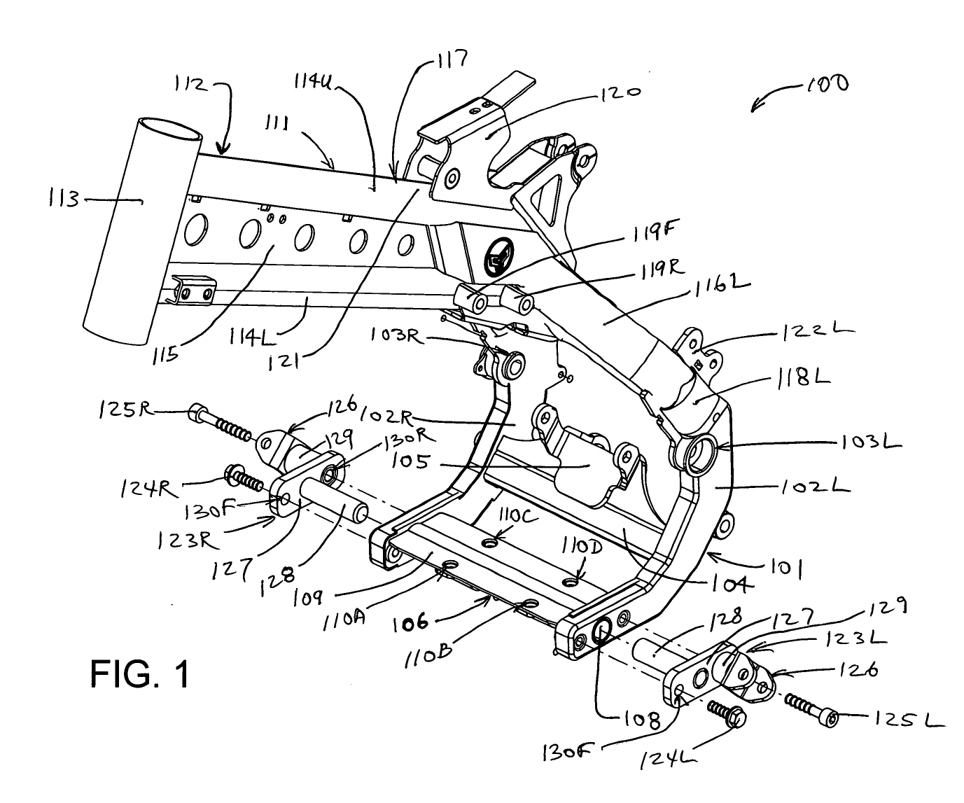

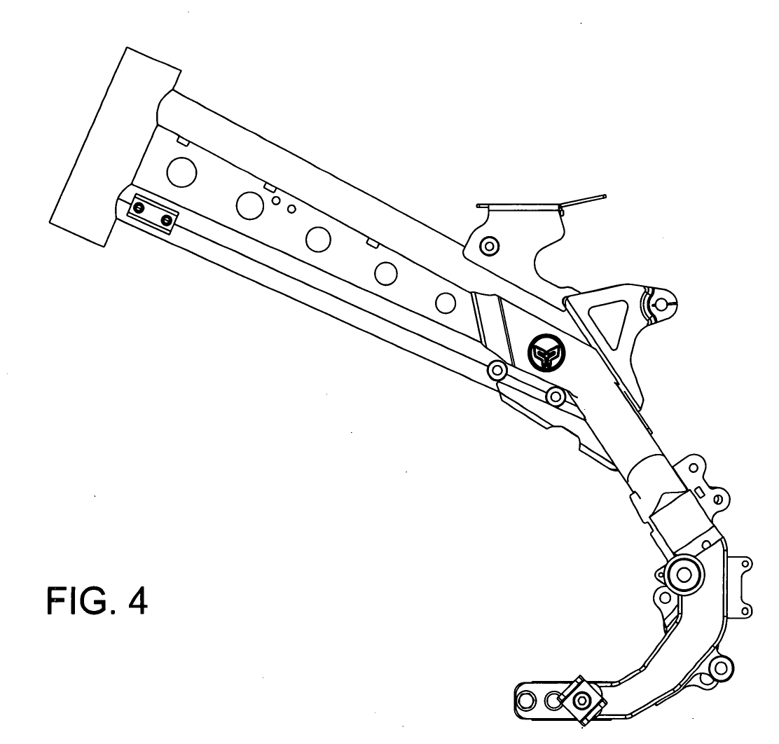

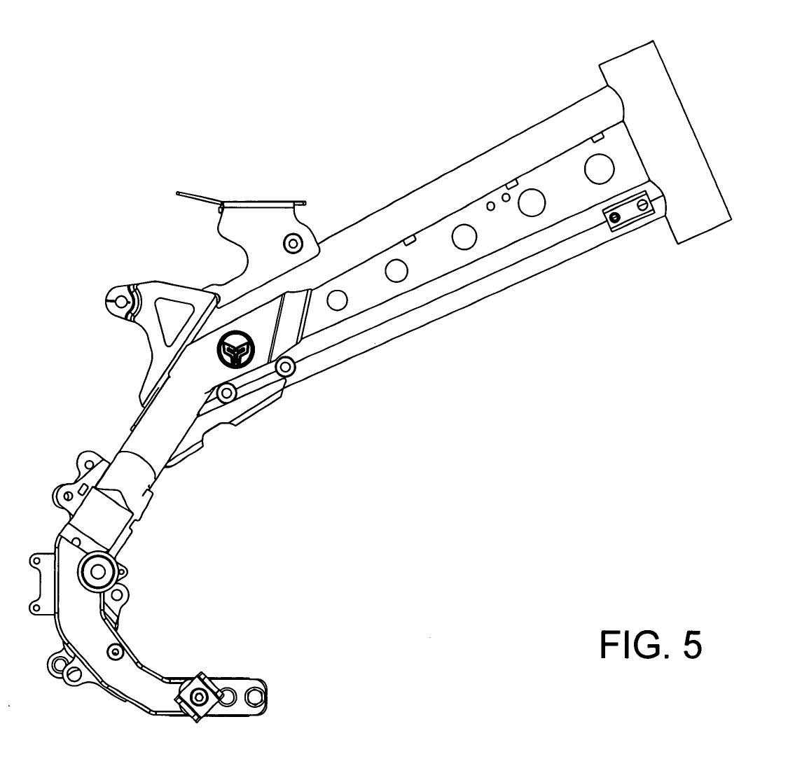

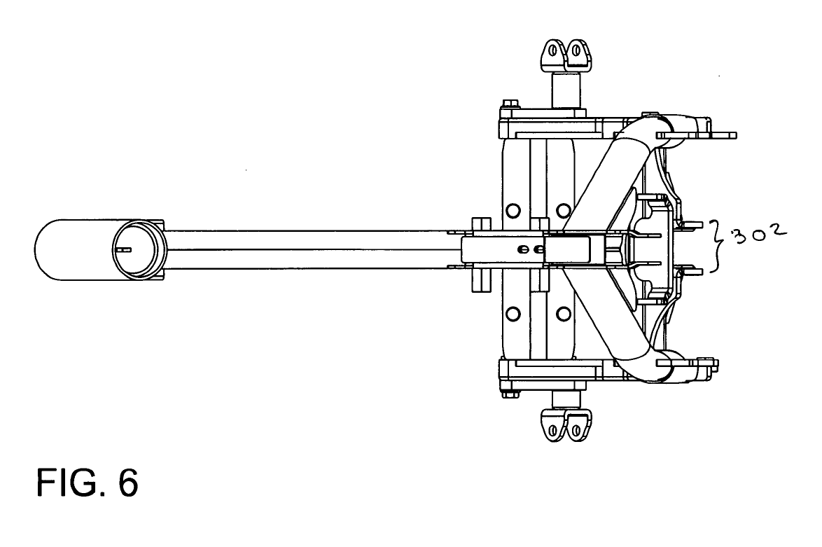

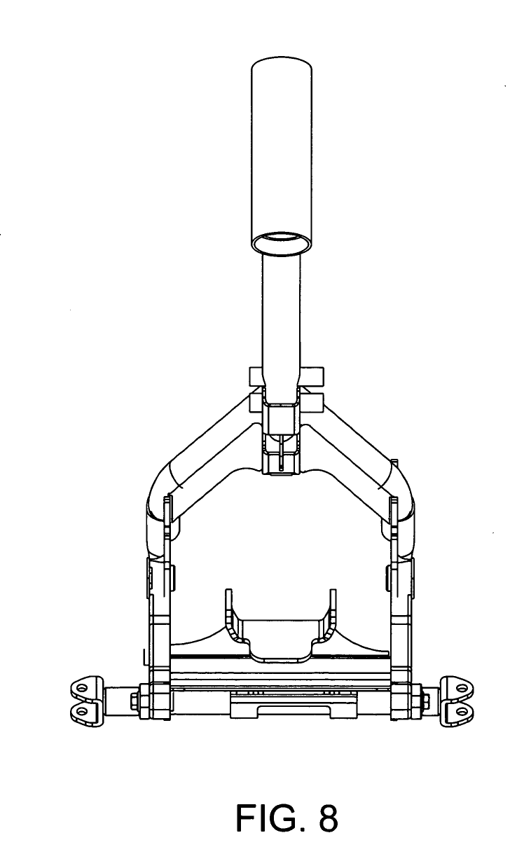

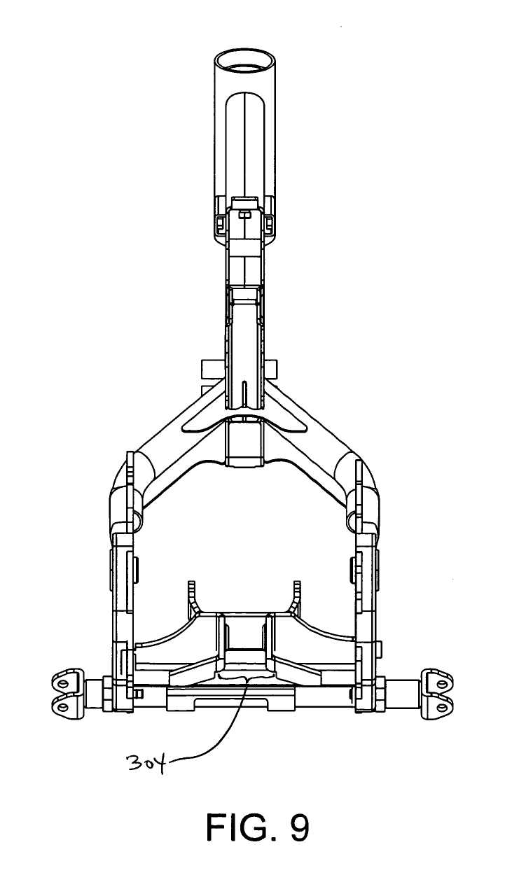

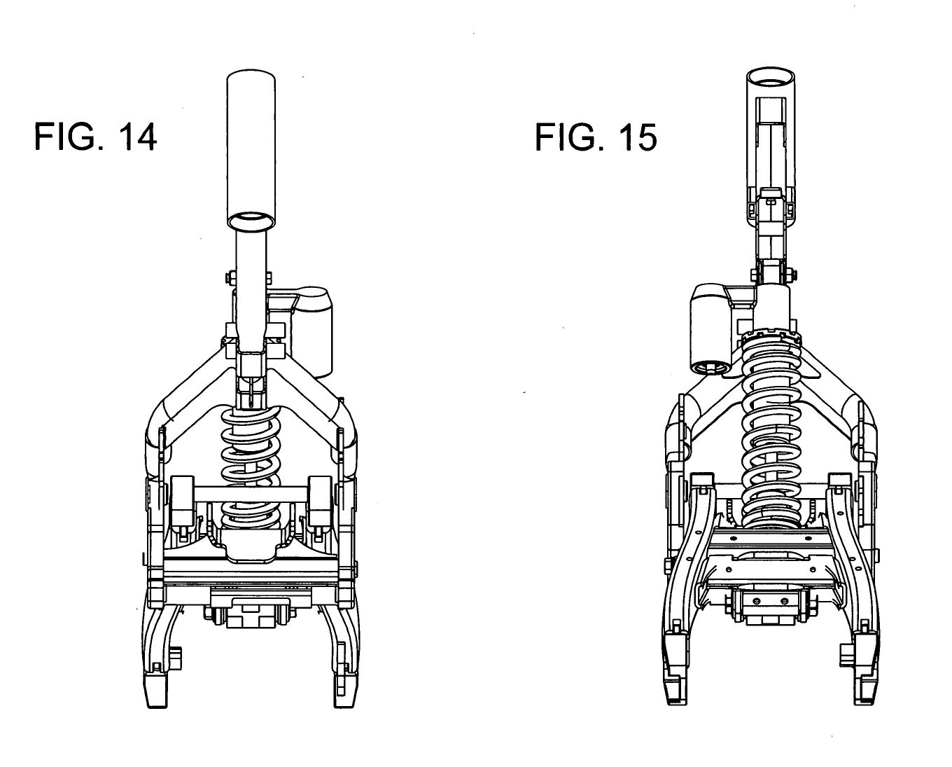

The invention will now be described with reference to the attached drawing FIGS. 1 through 15. It should be understood that although the drawings are intended to be merely illustrative, a reasonable attempt has been made to provide drawings that are close to scale.

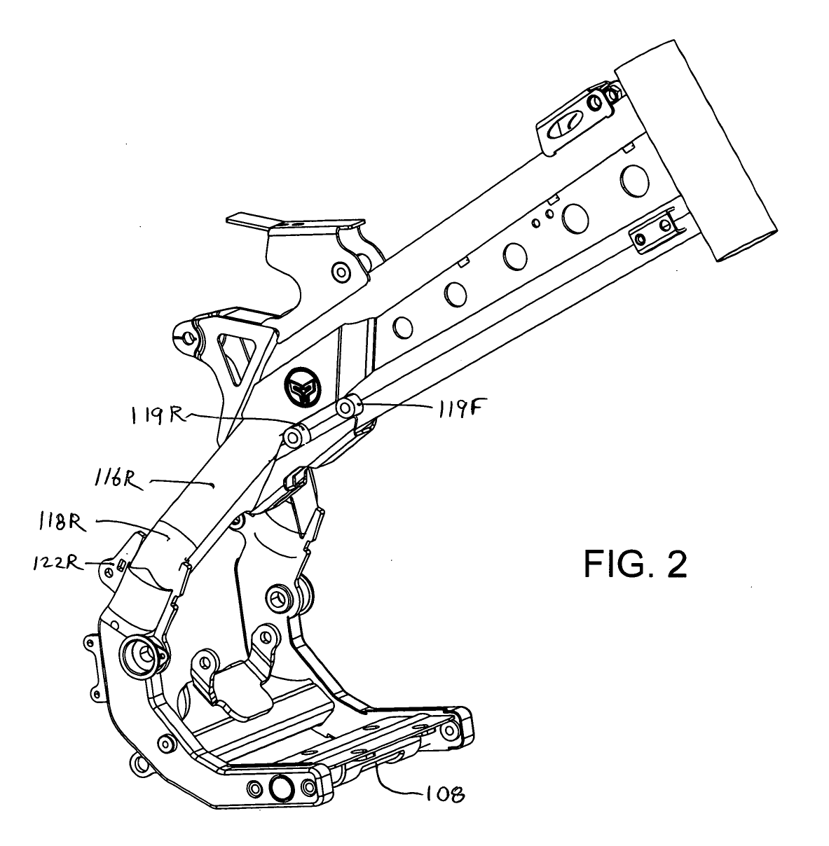

Referring now to FIGS. 1 and 2, the new backbone-type frame 100 of the present invention has a partial rear cradle 101 comprised of left and right, spaced-apart crescent, or C-shaped, box-section members 102L and 102R, respectively, which are fabricated primarily of stamped structural sheet metal, and which “cradle” opposite sides of a rear portion of a unitized horizontal single-cylinder engine/transmission unit (not shown). Each of the C-shaped box-section members 102L and 102R incorporates a rear swing arm attachment aperture 103L and 103R, and the swing arm (not shown in this view) is secured between the two apertures 103L and 103R with a swing arm pivot bolt (also not shown in this view). In addition, a rear brace 104 is welded to and interconnects the mid portions of both C-shaped box-section members 102L and 102R. A rear engine mount bracket 105 is secured to the forward-facing side of the rear brace 104. A rear mounting point on the engine/transmission unit can be bolted to the rear engine mount bracket 104. A lower brace 106 is welded to and interconnects the lower forward-extending portions 107L and 107R of the C-shaped box-section members 102L and 102R, respectively. For a preferred embodiment of the invention, the lower brace 106 includes a transverse tube 108 and a transverse plates 109 having a semicylindrical groove that fits over the transverse tube 108, the transverse plate 109 having a pair of spaced-apart front apertures 110A/110B and a pair of spaced-apart rear apertures 110C/110D. The four apertures 110A-110D align with the threaded apertures of the engine/transmission case which were originally intended for anchoring a footpeg bracket to the underside of the engine/transmission case. Each end of the transverse plate 109 is welded to a C-shaped box-section members 102L or 102R. The transverse tube 108, which passes through apertures formed in the C-shaped box-section members 102L and 102R, is also welded to at least the inner surfaces of the C-shaped box-section members 102L and 102R.

Still referring to FIGS. 1 and 2, the new backbone-type frame 100 also includes a spine 111, the anterior end 112 of which is welded to a head tube 113. A suspension fork assembly (not shown) is to be pivotally secured within the head tube 113. Pivotal installation of the suspension fork assembly provides steering capability for the motorcycle. For a preferred embodiment of the invention, the spine 111 is fabricated from a pair of upper and lower, generally parallel longitudinal tubes 114U and 114L, respectively, which extend the full length of the spinel 11, and a longitudinal plate 115 of the same length, which is welded to both longitudinal tubes 114U and 114L to form a modified I-beam structure. Left and right box-section struts 116L and 116R, respectively, which are welded to opposite sides of a posterior end 117 of the spine 111, together form a V configuration and also branch rearwardly and somewhat downwardly from the posterior end 117 of the spine 111. Each box-section strut 116L and 116R is welded to an upper portion 118L and 118R of one of the C-shaped box-section members 102L and 102R, respectively, thereby completing the basic structure of the new backbone-type frame 100. Left and right upper engine mount brackets (not shown), are removable and bolt to the mounting points 119F and 119R that are located on the posterior end 117 of the spine 111. The left and right upper engine mount brackets are also boltable to an upper mounting point on the engine/transmission case. The upper engine mount is a relatively low-stress frame component. Thus, the upper engine mount brackets (not shown), rather than the lower brace 106—which functions as a bottom engine mount—are made removable so that there is sufficient play between the engine and the frame after the upper engine mount bracket 119 is removed, so that the engine can be slightly elevated and easily slide out of the frame in a forward direction. A multi-purpose bracket 120, also welded to an upper edge 121 near the posterior end 117 of the spine 111, provides mounting points for a fuel tank and a seat and rear fender mounting framework (neither of which are shown in this view). The seat and rear fender mounting framework includes a pair of struts (also not shown), each of which has a lower end which is bolted to either a left or right mounting brackets 122L and 122R, which are located on the rear edge of an upper portion 118L and 118R of one of the C-shaped box-section members 102L and 102R.

Referring now specifically to FIG. 1, right and left footpeg mounting brackets 123R and 123L are shown spaced away from their mounting locations on the frame 100. The bolts used to secure the footpeg mounting brackets 123R and 123L to the frame 100 include a pair of hex bolts 124R and 124L and a pair of Allen bolts 125R and 125L. Allen bolts are used in the rear most positions because the heads thereof fit into a recess inboard of the socket 126 to which each footpeg is secured with a hinge pin (not shown). Each footpeg mounting bracket 123R and 123L includes a mounting plate 127, a cylindrical stud 128 secured to an inboard side of the mounting plate 127, and a standoff tube 129, which is welded to an outboard side of the mounting plate 127 and to which the socket 126 is welded. Each mounting plate 127 is equipped with a front bolt apertures 130F and rear bolt aperture 130R, which are used to secure the footpeg mounting brackets 123R and 123L to the frame 100. It will be noted that the rear bolt aperture 130R is coaxial with the standoff tube 129, hence the use of the Allen bolts 125R and 125L in the rear bolt apertures 130R. It will be noted that in order to install the footpeg mounting brackets on the frame 100, the cylindrical stud 128 of each footpeg mounting bracket 123R and 123L slides into one end of the transverse tube 108 and the mounting plate 127 is secured to its associated C-shaped box section member 102L or 102R with one hex bolt 124R or 124L and one Allen bolt 125R or 125L. Stresses and loads applied to the footpegs are transferred to the transverse tube 108, thereby greatly reducing stresses and loads applied to the attachment bolts 124R, 124L, 125R and 125L. A footpeg mounting brackets 123R or 123L can be easily replaced by simply removing the hinge pin and footpeg, and then the attachment bolts 124R/125R or 124L/125L, removing the old footpeg mounting bracket 123R or 123L, and installing a new one in its place.

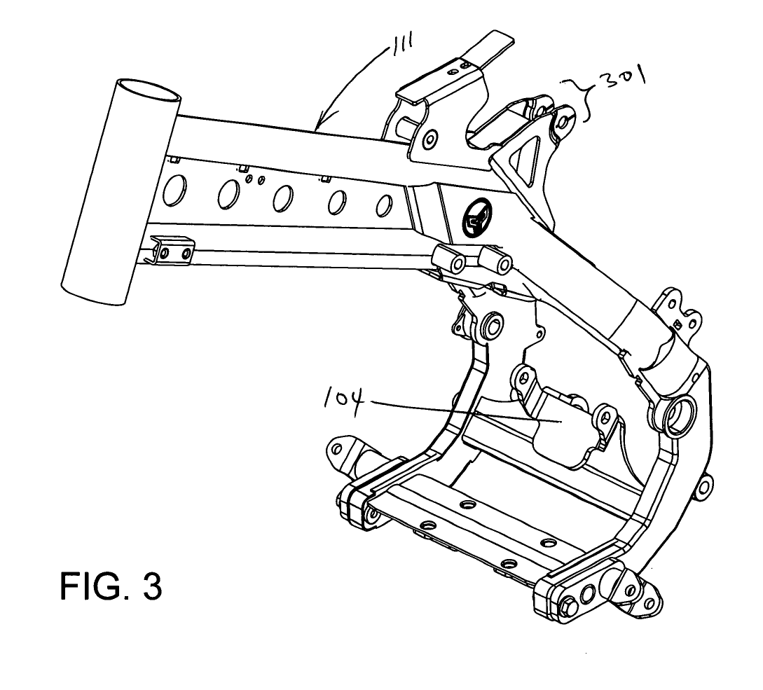

Referring now to FIGS. 3 through 9, an upper rear shock absorber/spring assembly mount 301 is welded to the posterior end of the spine 111. A forward rear suspension link mount 302 is welded to the rearward-facing side of the rear brace 104.

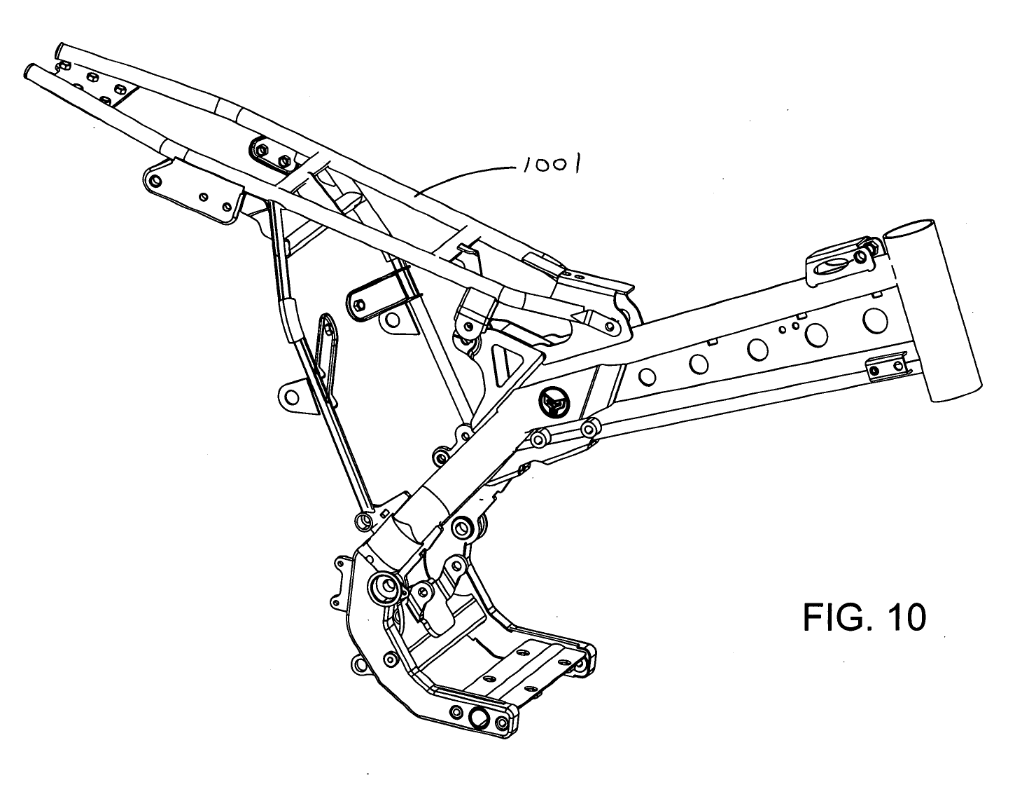

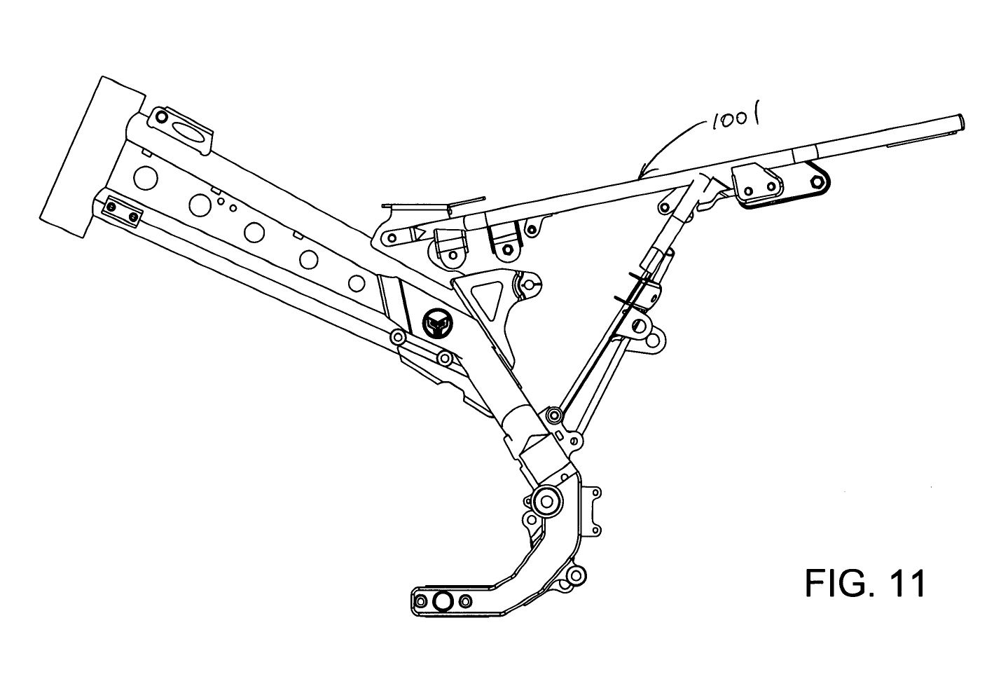

Referring now to FIGS. 10 and 11, the seat and rear fender mounting framework 1001 is shown properly positioned on the frame 100. The common hex bolts used to secure the framework 1001 to the frame 100 are not shown.

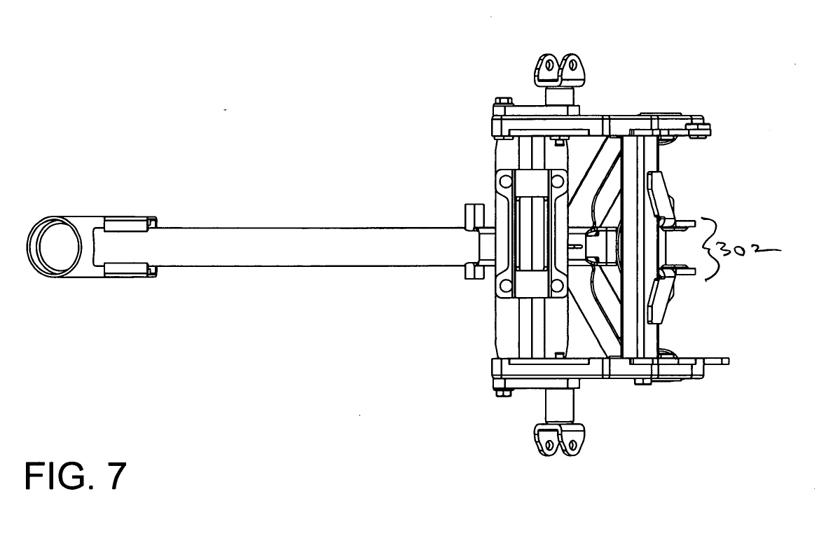

Referring now, specifically to FIGS. 7 through 9, it will be seen that a reinforcement plate 701 is positioned beneath both the transverse tube 108 and the transverse plate 109, and is welded to one or both. The reinforcement plate 701 has two front apertures 702A/702B, as well as two rear apertures 702C/702D. The four apertures are axially aligned with the front apertures 110A/110B and 110C/110D, respectively of the transverse plate 109.

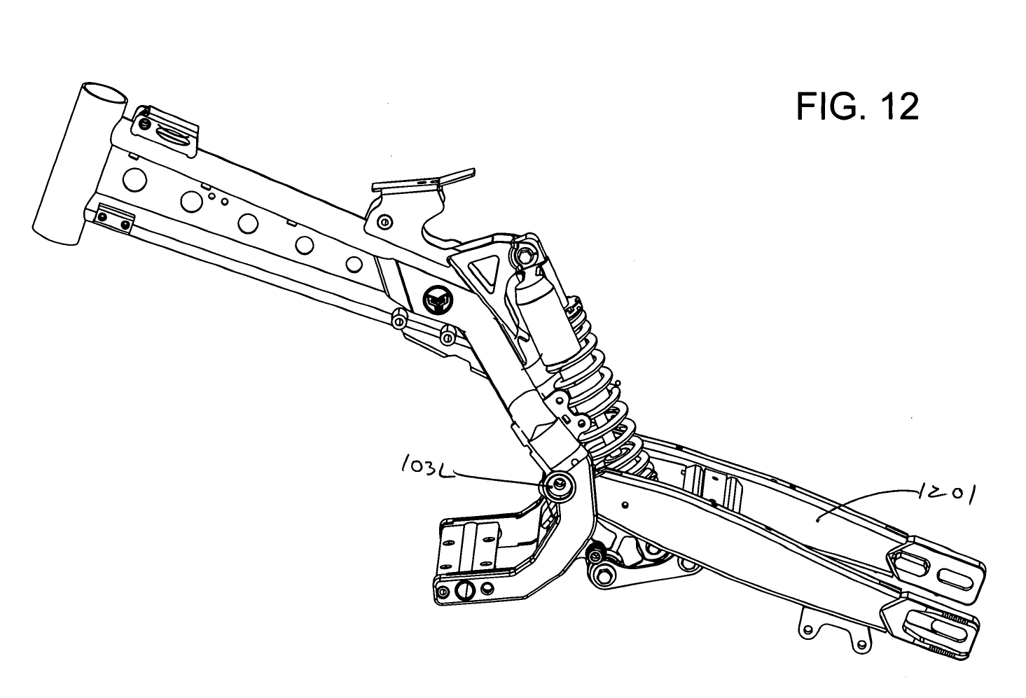

Referring now to FIGS. 12 through 15, a swingarm 1201 has been properly positioned in the new backbone-type frame 100 between the two swingarm pivot apertures 103L and 103R. The swing arm pivot bolt, which extends between the two swingarm pivot apertures 103L and 103R, is not shown.

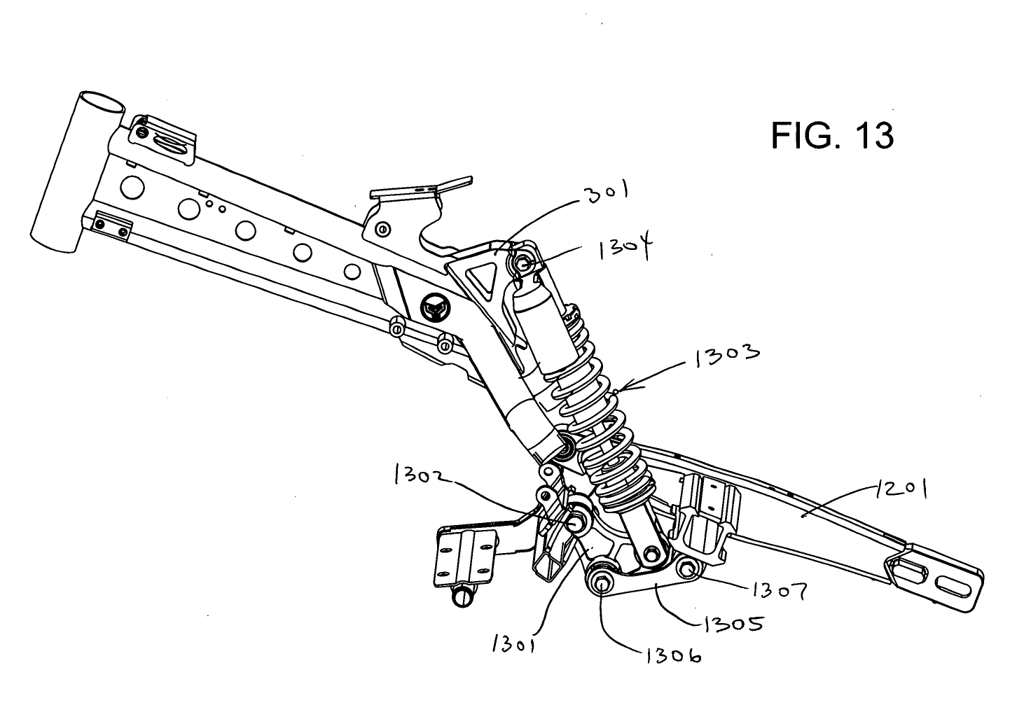

Referring now, specifically, to FIG. 13, a leading rear suspension link 1301 has been secured to the suspension link mount 302 with a first pivot bolt 1302. An upper end of a shock absorber/spring assembly 1303 has been bolted to the upper rear shock absorber/spring assembly mount 301 with an upper shock absorber bolt 1304, while the lower end of the shock absorber/spring assembly 1303 has been secured to the leading rear suspension link 1301. The front end of a trailing rear suspension link 1305 has been secured to the leading rear suspension link with a second pivot bolt 1306, and the rear end thereof has been secured to the swingarm 1201 with a third pivot bolt 1307.

Although only a single embodiment of the invention has been shown and described, it will be obvious to those having ordinary skill in the art that changes and modifications may be made thereto without departing from the scope and the spirit of the invention.

What is claimed is:

1. A motorcycle frame for supporting a unitized horizontal, single-cylinder engine and transmission assembly and to which front and rear wheels can be suspendedly attached, said frame comprising:
a head tube;
a rear frame assembly to which the unitized engine and transmission assembly is bolted and to which rear suspension components are attached, said rear frame assembly having a partial cradle that extends beneath and supports at least at least a portion of the unitized engine and transmission, said rear frame assembly having a pair of spaced-apart C-shaped box-section members interconnected by a transverse tube and a transverse plate that is superjacent the transverse tube, said transverse tube and said transverse plate being welded at opposite ends to said C-shaped box-section members, said transverse tube passing through each C-shaped box-section member;
a spine connecting the head tube to the rear frame assembly; and
footpeg mounting brackets, each of which has a stud which fits within an end of the transverse tube, each footpeg mounting bracket securable to a C-shaped box-section member with bolts.

2. The motorcycle frame of claim 1, which further comprises a rear suspension having:
a shock absorber/spring assembly, a top end of which is secured directly to the frame;
a swing arm, a forward end of which is pivotally mounted to the frame;
a trailing rear suspension link, a rear end of which is pivotally secured to the swing arm; and
a leading rear suspension link that is pivotally attached to the frame, to a bottom end of said shock absorber/spring assembly, and to the front end of the trailing rear suspension link.
